(19) United States
(12) Patent Application Publication
(10) Pub. No.: US 2006/0232238 A1
(43) Pub. Date: Oct. 19, 2006

(54) Battery charging system for hybrid electric vehicles

(76) Inventor: Yusuke Horii, Tokyo (JP)

Correspondence Address: JACOBSON HOLMAN PLLC, 400 SEVENTH STREET N.W., SUITE 600, WASHINGTON, DC, 20004, US

(21) Appl. No.: 11/391,702

(22) Filed: Mar. 29, 2006

(30) Foreign Application Priority Data
Mar. 29, 2005 (JP) 2005-96131

(51) Int. Cl. H02J 7/00; B60L 8/00

(52) U.S. Cl. 320/104; 180/65.3

(57) ABSTRACT

A battery charging system for hybrid electric vehicles that is capable of charging a low voltage battery with good energy efficiency. The battery charging system includes a high voltage battery for supplying electric power to a vehicle drive motor; and a voltage converter for converting a voltage, input from the high voltage battery, to a first voltage and outputting the first voltage. The battery charging system further includes a low voltage battery that is charged with the first voltage from the voltage converter; and an alternator, which is driven by an engine, connected with the low voltage battery in parallel with the voltage converter. The output voltage of the alternator is lower than the first voltage and higher than the rated voltage of the low voltage battery.

### BACKGROUND OF THE INVENTION

(1) Field of the Invention

The present invention relates to a battery charging system that is suitable for use in hybrid electric vehicles.

(2) Description of the Related Art

Hybrid electric vehicles have been put to practical use in recent years and include a generator for generating electric power by being driven with an engine, a vehicle drive battery (high voltage battery), a vehicle drive motor, etc. Hybrid electric vehicles are roughly classified into three types: (1) a parallel type in which driving wheels are rotated by using the driving force of the engine and the driving force of the vehicle drive motor in combination; (2) a series type in which driving wheels are rotated by the vehicle drive motor driven with electric power generated by driving the engine; and (3) a combination type of them.

In addition to the vehicle drive battery with a relatively high voltage (e.g. about 500 V), hybrid electric vehicles are further equipped with an electric equipment battery (low voltage battery) for storing a DC power that has a relatively low voltage (e.g. 24 V). This low voltage battery is used to operate vehicle-mounted electric equipment, which includes lamp equipment (such as head lamps, stop lamps, etc.), air-conditioning equipment (such as an air-conditioning compressor, capacitors, etc.), audio equipment (such as a car stereo set, etc.), control equipment (such as various controllers, brake vacuum pumps, etc.), and so forth.

FIG. 3 shows the electric circuit of the electric equipment power source unit of a conventional series type hybrid electric vehicle. As shown in the figure, a vehicle drive motor 110 is connected to driving wheels 111 so that power can be transferred. The vehicle drive motor 110 is further connected to a high voltage battery 103 through an inverter 109.

A generator 102 is connected to an engine 101 so that it can generate electric power by being driven with the engine 101, the operation thereof being controlled by a generator controller 107. The generator 102 is further connected to a high voltage battery 103 through an inverter 109 so that the generated electric power is supplied to the high voltage battery 103.

A low voltage battery 106 is connected to the high voltage battery 103 through a voltage converter (DC/DC converter) 104, and to vehicle-mounted electric equipment 105.

Therefore, if the electric power of the high voltage battery 103 is supplied to the vehicle drive motor 110 through the inverter 109, the vehicle drive motor 110 is rotated and the driving wheels 111 connected with the vehicle drive motor 110 are rotated, whereby the vehicle can travel. If the electric power stored in the high voltage battery 103 is reduced, the engine 101 is driven and the generator 102 is operated by the generator controller 107. The electric power generated by the generator 102 is accumulated and stored in the high voltage battery 103.

The electric power stored in the high voltage battery 103 is converted to a low voltage by the DC/DC converter 104 and stored in the low voltage battery 106. The vehicle-mounted electric equipment 105 is operated by the supply of electric power from the low voltage battery 106.

The power consumption of the low voltage battery 106 becomes extremely high when particular electric equipment with high power consumption (e.g. an air conditioner, headlights, etc.) is being operated. However, when such particular electric equipment is not operated, the power consumption of the low voltage battery 106 does not become so high.

Therefore, to deal with the case where the power consumption of the low voltage battery 106 is high, the DC/DC converter 104 can be replaced with one having a voltage conversion quantity that is greater than the power consumption of the low voltage battery 106. However, in the case where the power consumption of the low voltage battery 106 is not high, the voltage conversion quantity of the DC/DC converter 104 will leave too much margin and exceed specifications.

Normally, a DC/DC converter becomes larger in size and higher in cost as its voltage conversion quantity becomes greater. Therefore, to achieve a reduction in size and cost of hybrid electric vehicles, it is desirable to use a DC/CD converter that is as small in size, low in cost, and low in capacity as possible by preventing its voltage conversion quantity from leaving too much margin.

To solve the aforementioned problem, as indicated by a two-dot dash line in FIG. 3, a conventional auxiliary power source circuit is provided with an alternator 112 that generates electric power by being driven with the engine 101. The alternator 112 is connected with the low voltage battery 106 in parallel with the DC/DC converter 104. With this arrangement, electric power is supplied from two systems (which consists of the alternator 112 and DC/DC converter 104) to the low voltage battery 106. This technique is disclosed in Japanese Laid-Open Patent Publication No. Hei 10-174201 by way of example.

In this technique, since the DC/DC converter 104 shares the supply of electric power to the low voltage battery 106 with the alternator 112, the DC/DC converter 104 is able to use one having a voltage conversion quantity that is relatively small even in the case where a large quantity of electric power is demanded by the low voltage battery 106. This renders possible a further reduction in size and cost of hybrid electric vehicles.

The output voltages of the DC/DC converter 104 and alternator 112 are basically constant, but the voltages of their actual charging circuit sections vary with the magnitude of equipment load or state of the low voltage battery 106.

Therefore, in supplying electric power to the low voltage battery 106, it is necessary to set the voltage of the power supply side to the optimum input voltage of the low voltage battery 106.

Because of this, in prior art, for example, in the case of using the low voltage battery 106 in which the rated voltage is 24 V and the optimum input voltage is 28.5±3 V, the output voltages of the DC/DC converter 104 and alternator 112 are both set to 28.5 V (which is the optimum input voltage of the low voltage battery 106) so that electric power is supplied from both to the low voltage battery 106.

As a charging path from the power supply source to the low voltage battery 106, there are two paths: (1) a first path where the low voltage battery 106 is charged by the DC/DC converter 104 to which electric power is supplied from the generator 102 and (2) a second path where it is charged by the alternator 112 driven with the engine 101. Typically, the former has good energy efficiency.

Therefore, in the case of taking into account further energy saving and fuel cost reduction of hybrid electric vehicles, it is desirable that during normal conditions, the low voltage battery 106 be charged by the output power of the DC/DC converter 104, and it is also desirable that only when the power consumption of the low voltage battery 106 is high and the output voltage of the DC/DC converter 104 is insufficient, the electric power of the alternator 112 be supplied to the low voltage battery 106 complementarily.

However, in the aforementioned prior art, electric power is supplied from the DC/DC converter 104 and alternator 112 to the low voltage battery 106. Therefore, even in the case where sufficient electric power can be supplied from the DC/DC converter 104 to the low voltage battery 106, the electric power generated by the alternator 112 is also supplied to the low voltage battery 106. The torque consumed by the alternator 112 to generate electric power results in an increase in fuel costs of the engine.

### SUMMARY OF THE INVENTION

The present invention has been made in view of the circumstances described above. Accordingly, it is the primary object of the present invention to provide a battery charging system for hybrid electric vehicles which is capable of charging a low voltage battery with good energy efficiency.

To achieve this end, there is provided a battery charging system for hybrid electric vehicles, which comprises four major components (1) a high voltage battery for supplying electric power to a vehicle drive motor; (2) a voltage converter for converting a voltage, input from the high voltage battery, to a first voltage and outputting the first voltage; (3) a low voltage battery that is charged with the first voltage from the voltage converter; and (4) an alternator, which is driven by an engine, connected with the low voltage battery in parallel with the voltage converter. The output voltage of the alternator is lower than the first voltage and higher than the rated voltage of the low voltage battery.

According to the battery charging system of the present invention, the output voltage of the alternator is lower than the first voltage and higher than the rated voltage of the low voltage battery. Therefore, in the case where a demand for electric power from the low voltage battery is not so large, electric power from the voltage converter is mainly stored in the low voltage battery. Thus, in charging the low voltage battery with a simpler construction, charging can be performed with good energy efficiency.

In the battery charging system of the present invention, a voltage difference between the first voltage and the output voltage of the alternator is preferably set to a predetermined voltage difference or greater.

In the case where a demand for electric power from the low voltage battery is not so large, the supply of electric power from the alternator to the low voltage battery can be reliably prevented.

Preferably, the predetermined voltage difference is 2 V, the first voltage is 28.5 V, the rated voltage of the low voltage battery is 24 V, and the output voltage of the alternator is 26.5 V.

In this case, in charging the low voltage battery whose rated voltage is 24 V, charging can be performed with good energy efficiency.

### BRIEF DESCRIPTION OF THE DRAWINGS

The present invention will be described in further detail with reference to the accompanying drawings wherein:

FIG. 1 is an electric circuit diagram showing a system for charging a low voltage battery constructed in accordance with a preferred embodiment of the present invention;

FIG. 2 is a graph showing temporal changes in the output voltage of the DC/DC converter, output voltage of the alternator, and voltage of the charging circuit section in the preferred embodiment of the present invention, and also showing temporal changes in the current consumed by electric equipment and maximum current of the voltage converter; and

FIG. 3 is an electric circuit diagram showing the electric equipment power source unit of a conventional hybrid electric vehicle.

### DESCRIPTION OF THE PREFERRED EMBODIMENTS

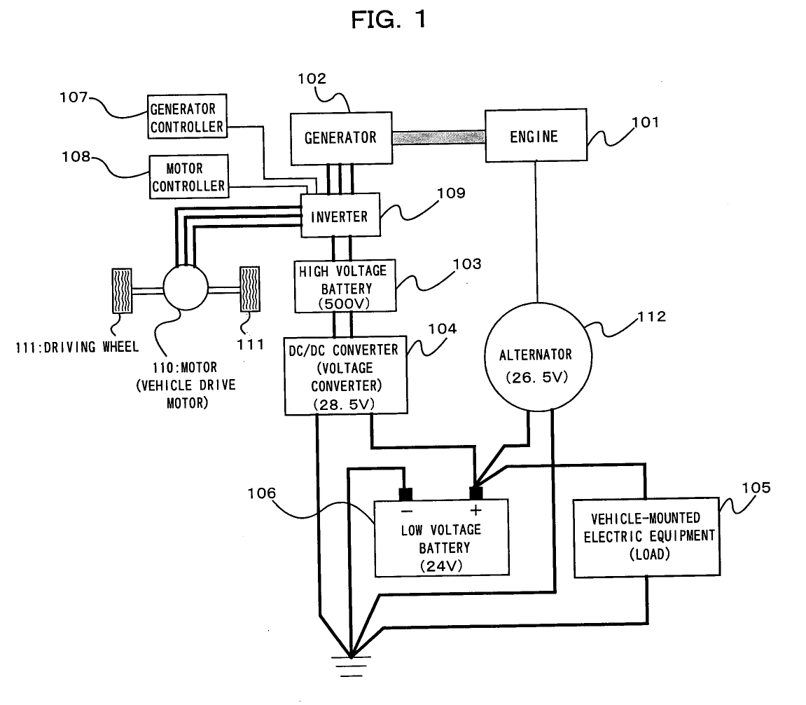

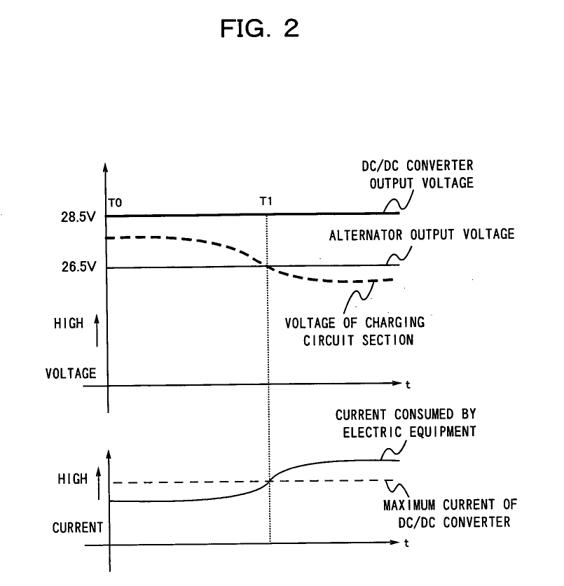

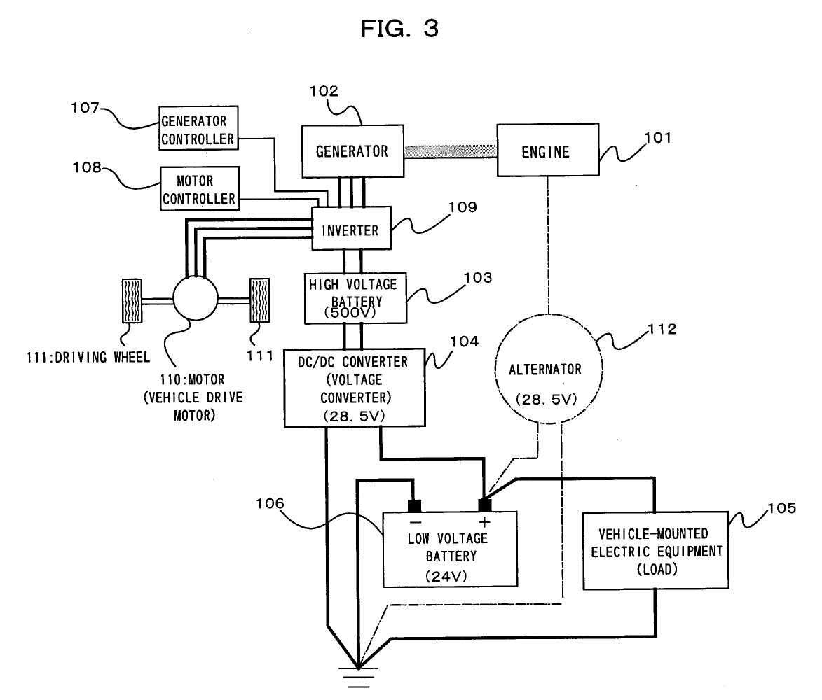

Referring to FIGS. 1 and 2, there is shown a battery charging system constructed in accordance with a preferred embodiment of the present invention. In FIG. 1, the same parts as the prior art in FIG. 3 are given the same reference numerals.

As shown in FIG. 1, the battery charging system of the preferred embodiment includes an engine 101, a motor controller 108, an inverter 109, a motor 110, driving wheels 111, a generator 102 that is driven by the engine 101, a high voltage battery 103, a DC/DC converter (voltage converter) 104, a low voltage battery 106 with an output voltage of 24 V, and an alternator 112 that is driven by the engine 101.

The vehicle drive motor 110 is connected to the driving wheels 111 so that power can be transmitted, and is further connected with the inverter 109. The generator 102 is connected to the engine 101 so that it can generate electric power by being driven with the engine 101. The generator 102 is controlled by the generator controller 107 and is connected through the inverter 109 to the high voltage battery 103 so that the generated electric power is used for charging. The generator 102 is further connected through the inverter 109 to the motor 110 so that the generated electric power is used to drive the motor 110. Note that the rated voltage VH of the high voltage battery 103 is 500 V in the preferred embodiment.

The low voltage battery 106 is connected with vehicle-mounted electric equipment 105, which includes lamp equipment (such as head lamps, stop lamps, etc.), air-conditioning equipment (such as a compressor, capacitors, etc.), audio equipment (such as a car stereo set, etc.), control equipment (such as brake vacuum pumps, etc.), and so forth. The low voltage battery 106 is further connected to the high voltage battery 103 through the DC/DC converter 104. The alternator 112 is connected with the engine 101 so that it can generate electric power by being driven with the engine 101, and is further connected to the low voltage battery 106. The generator controller 107 and motor controller 108 are included in the vehicle-mounted electric equipment 105.

The DC/DC converter 104 is set so that a direct current of high voltage VH (500 V) input from the high voltage battery 103 is converted to a direct current of low voltage V1 (28.5 V in this embodiment), and supplies electric power to the low voltage battery 106. The output voltage of the alternator 112 is set to a voltage V2 (26.5 V in this embodiment) lower than the output voltage V1 of the DC/DC converter 104 by a predetermined value (2 V in this embodiment). Thus, there voltages V1 and V2 are set higher than the rated voltage VL (24 V in this embodiment) of the low voltage battery 106.

The battery charging system of the preferred embodiment is constructed as described above. Therefore, if the main switch (not shown) of the vehicle is made on, the electric power stored in the high voltage battery 103 is supplied to the motor 110 through the inverter 109. Then, the motor 110 is driven, so that the driving wheels 111 connected to the motor 110 are rotated and the vehicle is caused to travel.

The electric power (direct current 500 V) stored in the high voltage battery 103 is converted to the voltage V2 (28.5 V) by the DC/DC converter 104 and stored in the low voltage battery 106. Then, the supply of electric power from the low voltage battery 106 causes the vehicle-mounted electric equipment 105 to operate.

If the electric power stored in the high voltage battery 103 is reduced, the engine 101 is driven so that the generator 102 is operated through control of the generator controller 108, and consequently, the electric power generated by the generator 102 is stored in the high voltage battery 103.

At this time, if electric equipment with high power consumption (e.g., a cooler, headlights, etc.) is operated by the supply of electric power from the low voltage battery 106, the power consumption of the low voltage battery 106 becomes greater than the power quantity that can be output from the DC/DC converter 104, and therefore the actual voltage of the high voltage circuit section (not shown) of the DC/DC converter 104 is reduced.

If the voltage of the charging circuit section becomes lower than the output voltage of the alternator 112, the electric power generated by driving the engine 101 is supplied from the alternator 112 to the low voltage battery 106.

The changes in the output voltages of the DC/DC converter 104 and alternator 12 and changes in the voltage of the charging circuit section at this time are shown in FIG. 2. As shown in the figure, in a time interval of T0 to T1, the voltage of the charging circuit section varies up and down slightly because of various factors, but is higher than the output voltage of the alternator 112. Therefore, the electric power stored in the high voltage battery 103 is mainly supplied to the low voltage battery 106 through the DC/DC converter 104.

After T1, the power consumption of the low voltage battery 106 becomes greater than the power quantity that can be output from the DC/DC converter 104, so that the voltage of the charging circuit section is lowered.

Therefore, after T1, in addition to the DC/DC converter 104, the electric power generated by driving the engine 101 is supplied from the alternator 112 to the low voltage battery 106.

That is, in the time interval after T1, the power consumption of the low voltage battery 106 becomes greater than the power quantity that can be output from the DC/DC converter 104, so that electric power is supplied from the DC/DC converter 104 and alternator 112 to the low voltage battery 106.

Therefore, in the time interval between T0 and T1 in FIG. 2, when the power consumption of the low voltage battery 106 is not so high, the electric power of the high voltage battery 103 reduced in voltage by the DC/DC converter 104 is mainly supplied to the low voltage battery 106 and therefore there is no possibility that as in prior art, electric power will be supplied from the alternator 112, which is bad in energy efficiency, to the low voltage battery 106. Thus, the low voltage battery 106 can be charged with good energy efficiency.

On the other hand, when the power consumption of the low voltage battery 106 is high, the electric power generated by the alternator 112, in addition to the electric power output from the DC/DC converter 104, is supplied to the low voltage battery 106 and therefore there is no possibility that even when the power consumption of the low voltage battery 106 is high, the electric power charged in the low voltage battery 106 will become insufficient. Because of this, since the power quantity that can be output from the DC/DC converter 104 can be reduced, the converter 104 can be reduced in size, cost, and capacity. This makes possible a reduction in size and cost of vehicles.

While the present invention has been described with reference to the preferred embodiment thereof, the invention is not to be limited to the details given herein, but may be modified within the scope of the invention hereinafter claimed.

For example, the values of the rated voltage VH of the high voltage battery 103, rated voltage VL of the low voltage battery 106, and output voltages V1 and V2 of the DC/DC converter 104 and alternator 104 are not limited to the values indicated in the preferred embodiment. As long as the output voltage of the alternator 112 is set lower than that of the voltage converter 104 by a predetermined voltage difference of ΔV0 or greater and higher than the voltage of the low voltage battery 106 by a predetermined voltage difference of ΔV1 or greater, many various values can be employed.

What is claimed is:

1. A battery charging system for hybrid electric vehicles comprising:
a high voltage battery for supplying electric power to a vehicle drive motor;
a voltage converter for converting a voltage, input from said high voltage battery, to a first voltage and outputting said first voltage;
a low voltage battery that is charged with said first voltage from said voltage converter; and
an alternator, which is driven by an engine, connected with said low voltage battery in parallel with said voltage converter;
wherein an output voltage of said alternator is lower than said first voltage and higher than a rated voltage of said low voltage battery.

2. The battery charging system as set forth in claim 1, wherein a voltage difference between said first voltage and the output voltage of said alternator is set to a predetermined voltage difference or greater.

3. The battery charging system as set forth in claim 2, wherein said predetermined voltage difference is 2 V, said first voltage is 28.5 V, said rated voltage of said low voltage battery is 24 V, and the output voltage of said alternator is 26.5 V.
